(19) United States
(12) Patent Application Publication
(10) Pub. No.: US 2017/0289404 A1
(43) Pub. Date: Oct. 5, 2017

(54) JOINT EDGE ENHANCE DYNAMIC

(71) Applicant: Intel Corporation, Santa Clara, CA (US)

(72) Inventor: Jun Nishimura, San Jose, CA (US)

(21) Appl. No.: 15/087,668

(22) Filed: Mar. 31, 2016

(51) Int. Cl. H04N 1/58; G06T 5/00

(52) U.S. Cl. CPC H04N 1/58; G06T 5/009; G06T 2207/10024; G06T 2207/20024; G06T 2207/20192

(57) ABSTRACT

A method and system for joint edge enhancement and mosaic are described. In one embodiment, the system comprises an image capture unit having an image capture sensor; and an image processor comprising a first module operable to perform joint edge enhancement and demosaic processing.

### FIELD OF THE INVENTION

Embodiments of the present invention relate to the field of color image processing; more particularly, embodiments of the present invention relate to a jointly performed edge enhancement and image demosaicing.

### BACKGROUND OF THE INVENTION

Many color cameras capture images use a color filter array over an image sensor to sample only one of the primary colors (red (R), green (G), blue (B)) at each pixel position. More specifically, the color filter array filters the incoming light so that each pixel of the image sensor receives only one of the primary colors. A commonly used color filter array is referred to as a Bayer pattern color filter array, which is described in U.S. Pat. No. 3,971,065.

Typically, the Bayer pattern color filter array selectively passes pixels to the image sensor so that a mosaic is produced with one-half of its pixels being green, one-quarter of its pixels being red, and one-quarter of its pixels being blue. That is, the captured green pixels G are only one-half of the total number of pixels captured by the image capture sensor, and the captured red pixels and blue pixels are each only one-quarter of the total number of pixels captured by the image capture sensor.

To obtain a complete full resolution set of pixels for each of the color components, a process referred to as demosaicing is used to reconstruct a full color image from the color samples that are output from an image capture sensor overlaid with a color filter array. Part of the demosaicing process usually requires interpolating the color image data. The interpolation process often uses an interpolation direction estimate to avoid any artifacts that result in a low image quality. The interpolation direction estimate may be determined using gradient information extracted from cross color intensity domains. Many of the conventional methods use an integrated gradient that extracts gradient information from either color intensity or color difference domains. In most cases, they resulted in fine direction estimate, but they fail at high frequency regions of the image, resulting in zipper, maze, and false color artifacts. If the interpolation direction is not accurate, resolution is degraded by wrong edge at the high frequency region.

Edge enhancement is well-known in the image processing art and is usually performed later in an image processing pipeline. That is, in an image processor, edge enhancement block is typically done at the end of pipeline. This block requires accurate edge direction estimate, which consumes most of the computation in the edge enhancement. For example, edge enhancement is often performed after demosaicing and after color processing.

### BRIEF DESCRIPTION OF THE DRAWINGS

The present invention will be understood more fully from the detailed description given below and from the accompanying drawings of various embodiments of the invention, which, however, should not be taken to limit the invention to the specific embodiments, but are for explanation and understanding only.

FIG. 1A illustrates a block diagram of an image capture system.

FIG. 1B illustrates a Bayer pattern.

FIG. 2 illustrates a data flow diagram of a typical image processor pipeline with edge enhancement at the end of the image processing pipeline.

FIG. 3 is a data flow diagram of one embodiment of an image processor pipeline with edge enhancement at the end of the image processing pipeline.

FIG. 4 is an example of a transform.

FIG. 5 is a data flow diagram of one embodiment of processing performed by a joint image enhancement and demosaic module.

FIG. 6 is a flow diagram of one embodiment of an image processing process.

FIG. 7 illustrates an example of a Bayer pattern with a 3×3 block of pixels in the center of the Bayer pattern highlighted.

FIG. 8 illustrates a portable image capture device 100 in accordance with one implementation.

FIGS. 9-11 are flow diagrams illustrating three different processes for adding the edge back into the base signal.

FIGS. 12 and 13 illustrate gain curves.

### DETAILED DESCRIPTION OF THE PRESENT INVENTION

In the following description, numerous details are set forth to provide a more thorough explanation of the present invention. It will be apparent, however, to one skilled in the art, that the present invention may be practiced without these specific details. In other instances, well-known structures and devices are shown in block diagram form, rather than in detail, in order to avoid obscuring the present invention.

In image processing by an image signal processor (ISP), both demosaic and edge enhancement require edge direction estimation. By combining demosaic and edge enhancement jointly into one single block or unit, this redundancy of direction estimate function is avoided. Since edge enhancement block consumes large amount computation cost, one joint edge enhancement and demosaic can be used to design very low cost ISP. In other words, by jointly enhancing edge information inside a demosaic module, one can omit a separate edge enhancement module in ISP for low cost ISP solution.

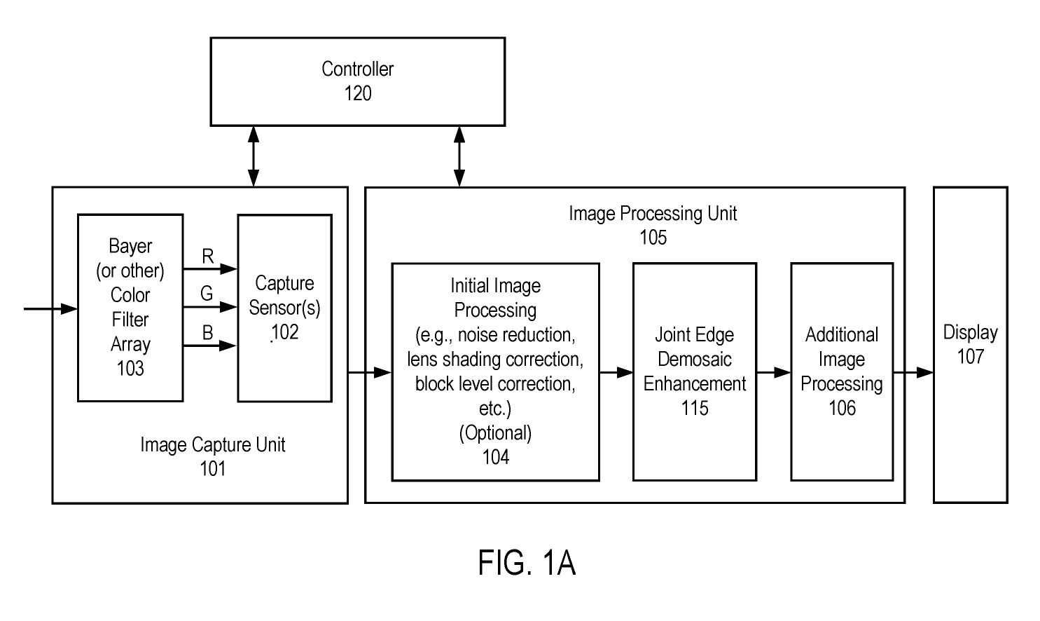

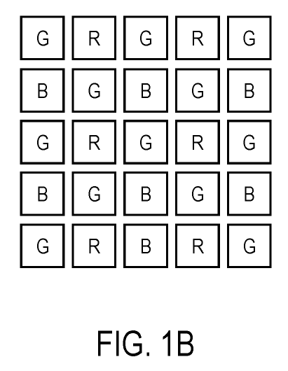

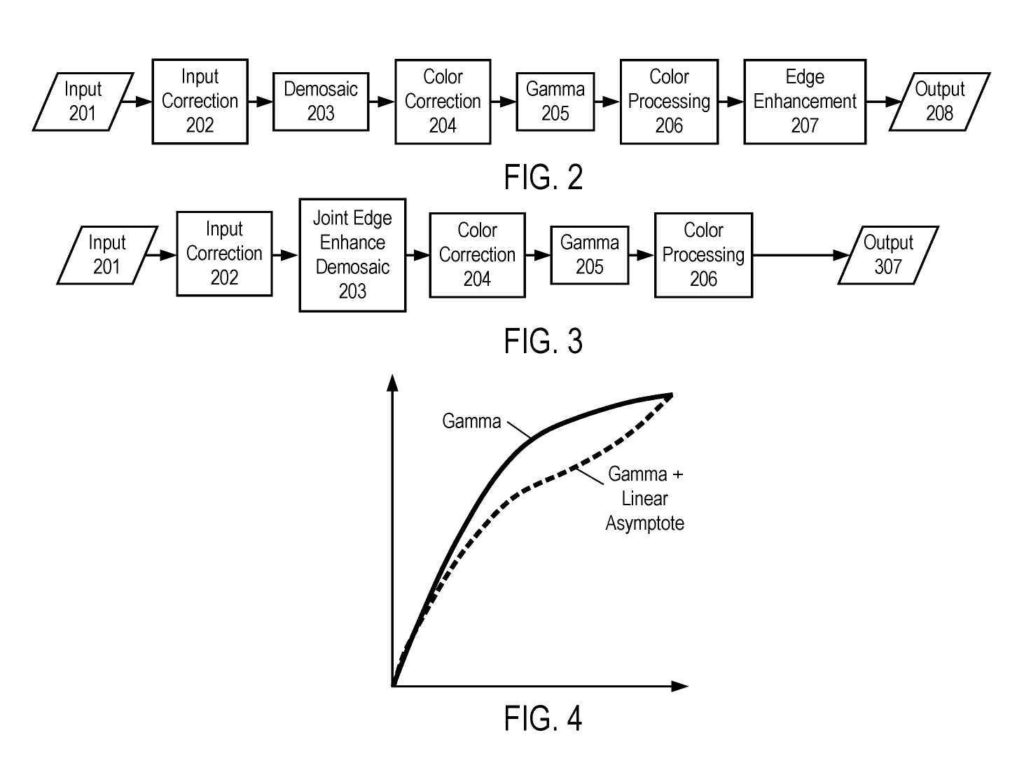

In one embodiment, the basic principle is to directly interpolate edges from the color filter array raw image. The interpolated edges for different directions are merged based on the accurate interpolation direction calculated by use of integrated gradient information. The base signal (low frequency component) can be calculated by a low pass filter. This base signal contains luminance and chrominance signals. The base signal is added to the merged edge when adding the merged edge to the base signal, one can add some gain to enhance the edge. After it is added back, the luminance/chrominance image can then be converted to a regular red, green, blue (RGB) image as a final output. FIG. 1A illustrates a block diagram of an image capture system. Referring to FIG. 1A, image capture system 100 includes an image capture unit 101 that includes a single-chip image capture sensor 102 with a Bayer color filter array 103. Bayer color filter arrays 103 has a pixel layout such as shown in FIG. 2. In one embodiment, image capture unit 101 captures a frame of pixels. In another embodiment, image capture unit 101 captures less than a frame of pixels.

A controller 120 controls frame capture and the transfer of captured frames to image processing system 105. Image processing system 105 performs a variety of techniques to improve the quality of the images that are sent to display unit 107. In one embodiment, image processing unit 105 optionally includes initial image processing 104. This may include, for example, but not limited to, noise reduction, lens shading correction, black level correction, etc. Joint edge enhancement and demosaic module 115 perform joint edge enhancement and demosaicing on image data captured by image capture unit 101. In one embodiment, image processing system 105 includes a joint edge enhancement and demosaic module 115 and additional image processing system 106. Additional image processing module 106 receives processed images from joint edge enhancement and demosaic module 115 and performs one or more additional image processing operations prior to display on display unit 107.

FIG. 2 is a data flow diagram of a typical image processor pipeline with edge enhancement at the end of the image processing pipeline. Referring to FIG. 2, an image input 201 undergoes input correction (202). In one embodiment, input correction (202) includes one or more of spatial noise reduction, sensor defect pixel correction, lens shading correction, black level correction, and white balance. After input correction, a demosaicing operation is performed on the corrected image (203) followed by color correction (204). After color correction (204), the image processor performs gamma correction (205) on the color corrected image and then color processing (206). It is only after color processing has been performed that the image processor performs edge enhancement (207). After performing edge enhancement, the image processor outputs the edge enhanced image at output 208.

By using joint edge enhance demosaic, the direction estimation portion is no longer needed in edge enhancement. FIG. 3 is a data flow diagram of one embodiment of an image processor pipeline with edge enhancement at the end of the image processing pipeline. Referring to FIG. 3, the demosaic operation is replaced by a joint edge enhancement and demosaic operation, and the edge enhancement operation that was at the end of the image processing pipeline in FIG. 2 is omitted.

The use of joint edge enhance demosaic has an advantage in preserving or enhancing low contrast details.

Another advantage of the proposed joint edge enhance demosaic is that it can be used to replace the existing demosaic solution for better detail preservation and image sharpness.

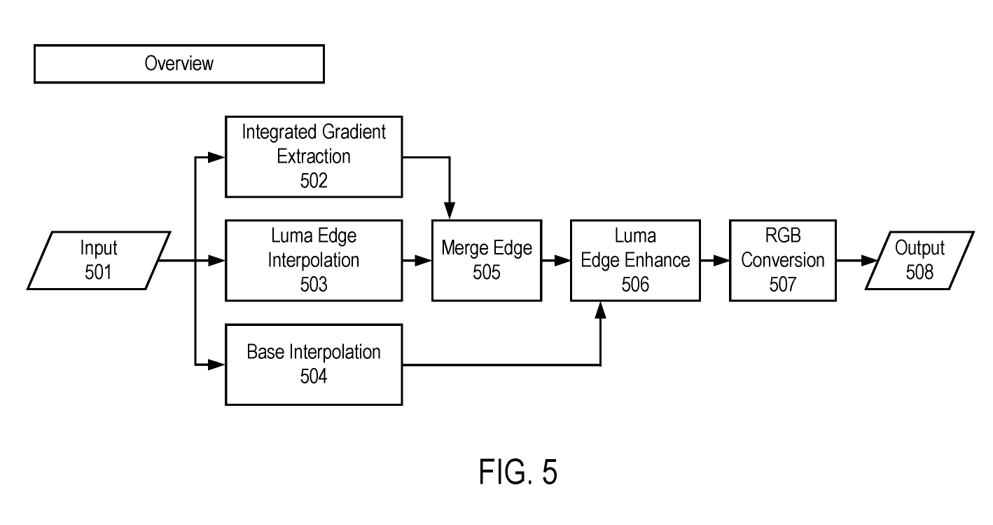

FIG. 5 is a data flow diagram of one embodiment of processing performed by a joint image enhancement and demosaic module. The processing is performed by processing logic that may comprise hardware (circuitry, dedicated logic, etc.), software (such as is run on a general purpose computer system or a dedicated machine), firmware, or a combination of these three. In one embodiment, the processing of FIG. 3 is performed by demosaic module 115 of FIG. 1.

Referring to FIG. 5, edge enhancement and demosaic are fused instead of having two separate subblocks—edge enhancement and demosaic in the same block. This is enabled by extracting edge (high frequency component) and a base signal (low frequency component) directly from a color filter array image. Unlike the typical demosaic operation in which different directional interpolation of G pixels are blended together, different directional edge is interpolated in the disclosed technologies. The method to obtain the direction information can be same as in the typical demosaic operation. In the conventional method, edge enhancement block needs to re-calculate direction information using demosaic output. In the disclosed technologies, this is not needed since the edge is already extracted.

### Luma Edge Interpolation

In one embodiment, an edges are interpolated by applying subsampled high pass filter on image data in the color filter array. For example, one can use ⅛[0−2 0−2 0; 2 0 4 0 2; 0−2 0−2 0] at G pixel positions and ⅛[−1 0−2 0−1; 0 2 0 2 0; −1 0−2 0−1] at non-G pixel positions for horizontal edges. This filter can be transposed to be used for interpolating vertical edge. In one embodiment, the non-directional edge is interpolated with the filter such as

$$\frac{1}{128} ( \begin{matrix}- 1 & 0 & - 6 & 0 & - 1 \\ 0 & 0 & 0 & 0 & 0 \\ - 6 & 0 & 28 & 0 & - 6 \\ 0 & 0 & 0 & 0 & 0 \\ - 1 & 0 & - 6 & 0 & - 1\end{matrix} ) at G , and$$

$$\frac{1}{128} ( \begin{matrix}0 & - 4 & 0 & - 4 & 0 \\ - 4 & - & 8 & - & - 4 \\ 0 & 8 & 0 & 8 & 0 \\ - 4 & 0 & 8 & 0 & - 4 \\ 0 & - 4 & 0 & - 4 & 0\end{matrix} ) at Non \text{-} G pixel positions .$$

In alternative embodiments, other filters are used, such as, but not limited to, one can use any high pass filter or band pass filter such as Difference of Gaussian (DoG) filter with larger filter size (e.g. 7×7, 9×9˜).

Thus, the result of luma edge interpolation is the creation of interpolated horizontal edge, interpolated vertical edges, and non-directional interpolated edges.

In one embodiment, in order to extract an edge that is more aligned with the human visual sensitivity, one can apply a non-linear transform to the input of the luma edge interpolation. This helps in recovering very weak texture. One example of such transform would be gamma transform. FIG. 4 illustrates a gamma transform.

### Integrated Gradient Extraction

Integrated gradient extraction block 502 calculates a metric for finding the correct direction to interpolate. In one embodiment, the metric is calculated by taking a local sum of the absolute gradients in different domains such as, for example, the color difference domain, the color intensity domain, and the inter-color intensity domain. The user may use one of the domains or a combination of these domains for the calculation. The use of the combination of all types of the domains gives the best results. The integrated gradient extraction is discussed in more detail below.

### Merging Edges

Merge edge block 505 leverages the local sums of directional gradients gradH (sum of horizontal gradients) and gradV (sum of vertical gradients), which are calculated in integrated gradient extraction block 502. As an example implementation, the edge direction strength can be calculated as

DEdgeStr=max(gradĤ2,gradĤ2)/(gradĤ2+gradV̂2).

In one embodiment, the edge non-directional strength can be calculated by locally summing vertical and horizontal gradients.as AEdgeStr. In one embodiment, this is calculated as:

AEdgeStr=(gradH+gradV).

In another embodiment, this is calculated by denoting filter coefficients described above in the Luma Edge Interpolation section as H_{A}, I_{Raw} as input raw image, AEdge as the output of convolution between filter H_{A} and I_{Raw}.

H_{A}*I_{Raw}=AEdge.

In this case, in one embodiment, AEdgeStr is calculated as

AEdgeStr=HLPF*AEdge

wherein HLPF equals 1/16 [1 2 1; 2 4 2; 1 2 1].

The weight for each edge components is adjusted by tuning parameters such as gain and threshold as in

W_{AEdge}=min(max(0.0,AEdgeStr−Threshold_{A})*Gain_{A}),1.0*(1.0−W_{DEdge}),W_{DEdge}=min(max(0.0,DEdgeStr−Threshold_{E})*Gain_{E}).

Then, the edges are merged as

Edge=W_{DEdge}*DEdge+W_{AEdge}*AEdge,

where DEdge is either a horizontal edge or a vertical edge with lower integrated gradient value and AEdge is the non-directional edge.

### Luma Edge Enhancement

In one embodiment, luma edge enhancement block 506 adds the edge component back into the base signal. In one embodiment, luma edge enhancement block 506 applies gain to the edge to enhance the signal. Here edge enhance strength is controlled by local luminance, which is provided by the result of base interpolation module 504. In other words, the arrow from base interpolation module 504 shown in FIG. 5 includes the luminance information to control the edge enhancement. Thus, this is luma dependent edge enhancement.

More specifically, in one embodiment, to add the edge component back into the base signal, three operations are performed: coring, applying gain, and clamping. During the coring operation, the noise components are removed from the calculated edge.

Edge=sign(Edge)*max(|Edge|−Edge_thres,0),

where Edge_thres is a certain threshold set to remove the noise components. It can be a function of local luminance, as the noise level can be dependent on the luminance. In one embodiment, applying gain is performed according to:

Edge=alpha*Edge,

where alpha is a gain applied to Edge. In one method, alpha can be a function of local luminance, which can be taken from base signal luma. In another method, it can be a function of expected luma signal taking into account the color correction which will be applied after demosaic. In this case, one can use 3×3 color correction matrix M_{CCM} and multiply it to the base (luma and chroma) to obtain the expected luminance value. Then, alpha can by controlled using this new luminance value. Finally, in one embodiment, clamping involves clipping the input to certain value Edge value, such as according to:

Edge=min(max(Edge,Edge_min),Edge_max).

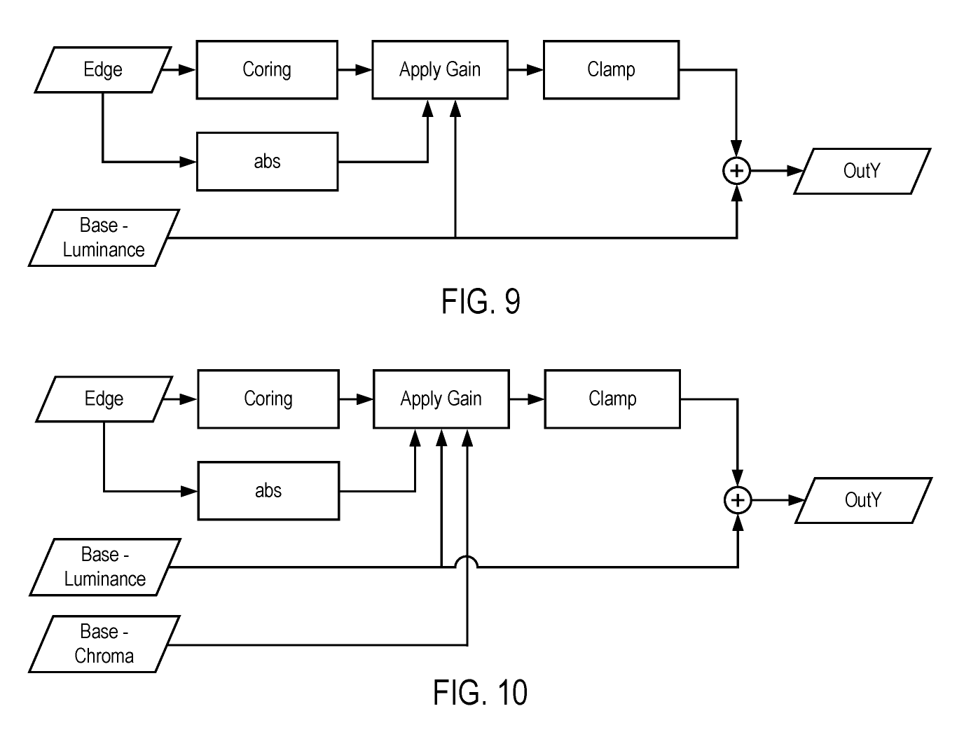

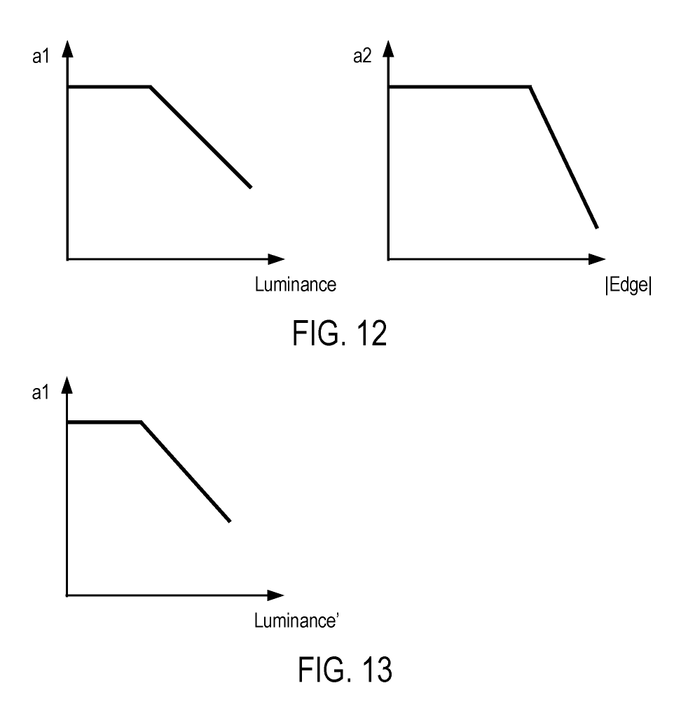

FIGS. 9-11 are flow diagrams illustrating three different processes for adding the edge back into the base signal. The process of FIG. 9 takes into account of the local luminance and absolute value of the edge in calculating the edge enhancement gain. An example relationship for the luminance dependent gain and absolute value of the edge shown in FIG. 12. In one embodiment, the final gain alpha is calculated as:

alpha=a1*a2.

The process in FIG. 10 takes into account the local chroma (color components). In this case, in one embodiment, the expected luminance is calculated by multiplying a 3×3 color correction matrix M_{CCM} (which will be used in the later stage of the image processing pipeline) to the base luminance and chrominance:

Base=[YC1C2]^{T}

Expected:=[Y′C1′C2′]^{T}=Base*M_{CCM}

FIG. 13 illustrates an example of a curve of gain alpha a1 versus luminance′.

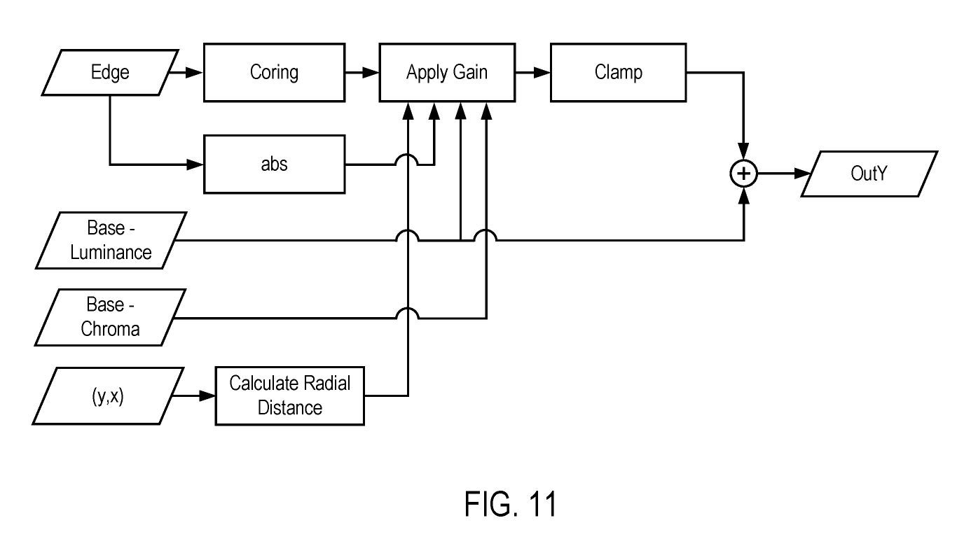

The process in FIG. 11 takes into account the distance from the image center. Since the image corner regions have more noise than the image center due to lens shading correction, in one embodiment, the edge enhancement gain is reduced at the image corners to avoid too much noise being amplified.

### Base Interpolation

Base interpolation module 504 generates an interpolated version of luma (luminance) base signal. This base signal is the low frequency signal in the image. In one embodiment, the base signal is interpolated by using certain low pass filter. For example, in one embodiment, the G pixels of base signal are first bilinearly interpolated, followed by bilinearly interpolate G−R or G−B color difference values. Then, base interpolation module 504 adds these two interpolated results to generate a low frequency estimate of R, G, B. The luminance of a color filter array image can be formulated as (R+2G+B)/4, while the chrominance (chroma) can be formulated as C1=(−R+2G−B)/4 and C2=(R−B)/2. The base luminance is used later at the Luma Edge Enhancement. The output luminance is given by:

Output Luminance=Base Luminance+Edge

The chrominance is used for the final output. If the output format is RGB, then both luminance and chrominance are used to convert into output RGB. The chrominance carries color information.

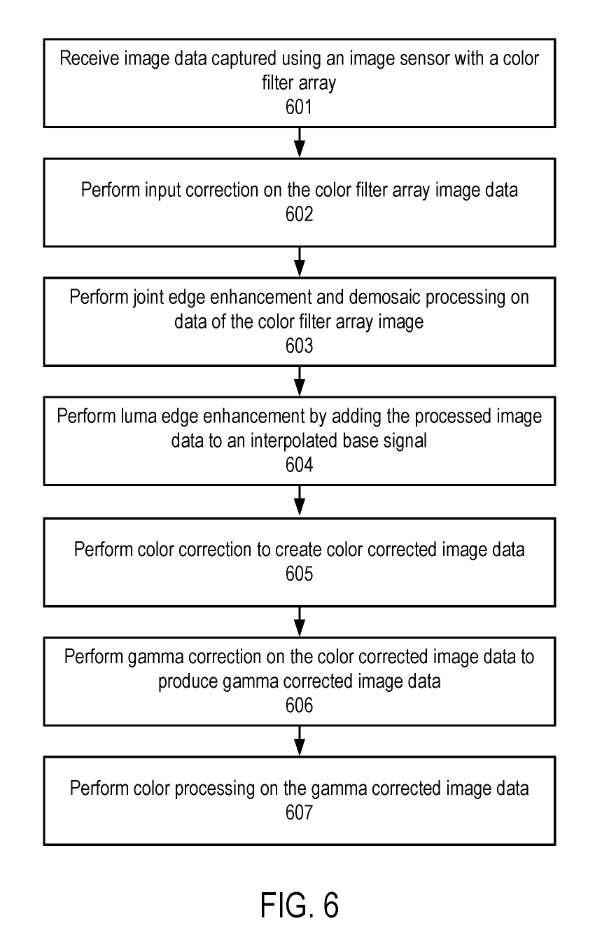

FIG. 6 is a flow diagram of one embodiment of an image processing process. In one embodiment, the process is performed by processing logic that may comprise hardware (circuitry, dedicated logic, etc.), software (such as is run on a general purpose computer system or a dedicated machine), firmware, or a combination of the three.

Referring to FIG. 6, the process begins by processing logic receiving image data captured using an image sensor with a color filter array (processing block 601). Next, processing logic performs input correction on the color filter array image data (processing block 602).

After input correction, processing logic performs joint edge enhancement and demosaic processing on data of the color filter array image (processing block 603). In one embodiment, the joint edge enhancement and demosaic processing includes extracting edge information and a base signal directly from the color filter array image data.

In one embodiment, joint edge enhancement and demosaic processing comprises performing luma edge interpolation on image data from the color filter array image, generating direction information indicative of an interpolation direction, and merging edges for different directions based on the direction information to generate processed image data. In one embodiment, processing logic applies a non-linear transform to an input of the luma edge interpolation. In one embodiment, the non-linear transform comprises a gamma transform. In one embodiment, generating the direction information indicative of an interpolation direction comprises performing integrated gradient extraction.

After performing joint edge enhancement and demosaic processing, processing logic performs luma edge enhancement by adding the processed image data to an interpolated base signal (processing block 604).

Using the luma edge enhanced image, processing logic then performs color correction to create color corrected image data (processing block 605), performs gamma correction on the color corrected image data to produce gamma corrected image data (processing block 606), and then performs color processing on the gamma corrected image data (processing block 607) to produce an output of the image processing pipeline.

### Integrated Gradient Extraction

In one embodiment, integrated gradient extraction module 502 calculates the local accumulation of gradient in different domain (namely, integrated gradient), which is used to estimate the appropriate interpolation direction. Luma edge interpolation 503 supplies different directional and non-directional edges to merge edges block 505, so that merge edges block 505 can merge them with respect to the metric supplied by integrated gradient extraction module 502. In one embodiment, the interpolation direction is determined based on the calculation of one or more metrics. In other words, integrated gradient extraction module 502 generates a metric(s) used to estimate an appropriate interpolation direction to use in controlling the blending performed by merge edge module 305. The integrated gradient is the local accumulation of gradient in a different domain. In one embodiment, when calculating a value of the “integrated gradient” for a 5×5 image region, the sum of the gradients calculated from this 5×5 region is taken. Integrated gradient extraction module 502 generates control inputs for blend module 306 based on raw image input 301.

In one embodiment, integrated gradient extraction module 502 performs a calculation to determine a horizontal gradient score and a vertical gradient score. Based on a comparison of the scores, which is indicative of the interpolation direction, integrated gradient extraction module 502 determines how a missing color pixel value should be computed. That computation, in one embodiment, is based, at least in part, on a value interpolated horizontally or vertically. In general, the interpolation direction is chosen to interpolate along edges rather than across edges.

In one embodiment, in contrast to the state-of-arts methods of color-intensity (CI) and color difference (CD) domains which are well-known in the art, embodiments described herein use inter-color intensity for integrated gradient extraction module 502. Each of these will be discussed below to more clearly set forth below for clarification purposes.

The color intensity domain gradient is the gradient within each color channel. The use of this measure assumes that the intensity of this gradient will be smaller in the direction of edge. The color intensity gradient in horizontal and vertical can be written as

$${δ}_{CI}^{H} ( y , x ) = {\sum }_{( i , j ) ∈ Ω} {w}_{CI} ( i , j ) \vert Z ( y + i , x + j - 1 ) - Z ( y + i , x + j + 1 ) \vert$$

$${δ}_{CI}^{V} ( y , x ) = {\sum }_{( i , j ) ∈ Ω} {w}_{CI} ( i , j ) \vert Z ( y + i , x + j ) - Z ( y + i + 1 , x + j ) \vert$$

where (y,x) are the vertical and horizontal coordinates in the image region (e.g., kernel, where (0,0) in kernel Ω is the center of kernel Ω); Z(y,x) refers to input raw image at (y,x) (which is the center pixel of a region); W_{CI}(i,j) as weight function within a certain kernel and in one embodiment, ranges from [0.0, 1.0], and can be set as a Gaussian function); Ω is a pre-defined kernel in consideration for this metric (e.g., the image region used to calculate the gradient), e.g. 5×5 image with respect to (y,x).

The color difference domain gradient metric assumes that the color difference is smooth along the edge. Thus, the comparison of horizontal and vertical color difference gradient will give the interpolation direction. The color difference (chroma) gradient in horizontal and vertical can be written as

$${δ}_{CD}^{H} ( y , x ) = {\sum }_{( i , j ) ∈ Ω} {\sum }_{n = 1}^{ } \vert \begin{matrix}\frac{( Z ( y + i , x + j + n ) - Z ( y + i , x + j - n ) )}{{N}_{n}} - \\ \frac{Z ( y + i , x + j + n + 1 ) - Z ( y + i , x + j - n - 1 )}{{M}_{n}}\end{matrix} \vert$$

$${δ}_{CD}^{V} ( y , x ) = {\sum }_{( i , j ) ∈ Ω} {\sum }_{n = 1}^{ } \vert \begin{matrix}\frac{( Z ( y + i + n , x + j ) - Z ( y + i - n , x + j ) )}{{N}_{n}} - \\ \frac{Z ( y + i + n + 1 , x + j ) - Z ( y + i - n - 1 , x + )}{{M}_{n}}\end{matrix} \vert$$

where 1/Nₙ, 1/Mₙ ranges from [0.0, 1.0], configured to accommodate different weight to the gradient calculated at different spatial position within the kernel Ω; and n is the spatial position index, with a maximum value that depends on the size of the kernel Ω.

Then, the gradients of 2 domain types are accumulated with certain weights to give a metric for determining the interpolation direction and each reliability.

δ^{H}(y,x)=α·δ_{CD}^{H}(y,x)+(1−α)·δ_{CI}^{H}(y,x)

δ^{V}(y,x)=α·δ_{CD}^{V}(y,x)+(1−α)·δ_{CI}^{V}(y,x)

For example, if f(δ^{H}(y,x), δ^{V} (y,x), σ)>0, the interpolation directions is determined to be horizontal, while if f(δ^{H} (y,x), δ^{V} (y,x), σ)<0, then the interpolation directions is determined to be vertical.

In a high frequency region, these two well-known domains for integrated gradient extraction often fail. This means they fail to distinguish the horizontal and vertical edges correctly. As a result, the output image has wrongly selected vertical edges at the horizontal regions. This is a root cause of the typically difficult image quality issues in using the demosaic algorithm.

To overcome this issue, in one embodiment, integrated gradient extraction module 502 uses an inter-color intensity domain for gradient calculation using the following equations:

$${δ}_{ICI}^{H} ( y , x ) := {\sum }_{( i , j ) ∈ Ω} {\sum }_{n = 0}^{ } \vert \begin{matrix}\frac{( Z ( y + i , x + j - n ) + Z ( y + i , x + j + n ) )}{{N}_{n}} - \\ \frac{( Z ( y + i , x + j - n - 1 ) + Z ( y + i , x + j + n + 1 ) )}{{M}_{n}}\end{matrix} \vert$$

$${δ}_{ICI}^{V} ( y , x ) := {\sum }_{( i , j ) ∈ Ω} {\sum }_{n = 0}^{ } \vert \begin{matrix}\frac{( Z ( y + i - n , x + j ) + Z ( y + i + n , x + j ) )}{{N}_{n}} - \\ \frac{( Z ( y + i - n - 1 , x + j ) + Z ( y + i + n + 1 , x + j ) )}{{M}_{n}}\end{matrix} \vert$$

where normalization factors 1/Nₙ, 1/Mₙ range from [0.0, 1.0] in one embodiment, and are configured to accommodate different weight to the gradient calculated at different spatial positions within the kernel Ω; and n is the spatial position index, with a maximum value that depends on the size of kernel Ω. In one embodiment, N and M are chosen by the demosaic module designer based on, for example, the location of the gradients calculated with respect to the center pixel of the kernel. Note that higher values for the normalization factor may be used to weight them lower.

The inter-color intensity domain gradient treats all input as they are part of the color channels in which the color different between adjacent pixels is made (instead of restricting the calculation to the same color channels). In other words, the color intensity gradient calculations involve pixel values of green pixels and at least one other color (red pixels, blue pixels). In one embodiment, the different weights include higher weights for pixels closer to the center and lower weights for pixels away from the center.

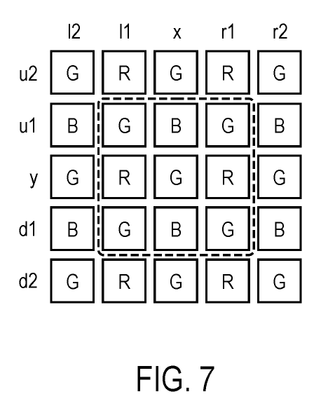

FIG. 7 illustrates an example of a Bayer pattern with a 3×3 block of pixels in the center of the Bayer pattern highlighted. The above formula for the horizontal gradient score (value) with n equals 0 , Ω: 3×3, and Nₙ & Mₙ equal may be applied:

$${δ}_{ICI}^{H} ( y , x ) := \vert Z ( u 1 , l 1 ) - ( Z ( u 1 , l 2 ) + Z ( u 1 , x ) ) / 2 \vert + \vert Z ( u 1 , x ) - ( Z ( u 1 , l 1 ) + Z ( u 1 , r 1 ) ) / 2 \vert + \vert Z ( u 1 , r 1 ) - ( Z ( u 1 , x ) + Z ( u 1 , r 2 ) ) / 2 \vert + \vert Z ( y , l 1 ) - ( Z ( y , l 2 ) + Z ( y , x ) ) / 2 \vert + \vert Z ( y , r 1 ) - ( Z ( y , x ) + Z ( y , r 2 ) ) / 2 \vert + \vert Z ( d 1 , l 1 ) - ( Z ( d 1 , l 2 ) + Z ( d 1 , x ) ) / 2 \vert + \vert Z ( d 1 , x ) - ( Z ( d 1 , l 1 ) + Z ( d 1 , r 1 ) ) / 2 \vert + \vert Z ( d 1 , r 1 ) - ( Z ( d 1 , x ) + Z ( d 1 , r 2 ) ) / 2 \vert$$

### An Example Image Capture Device

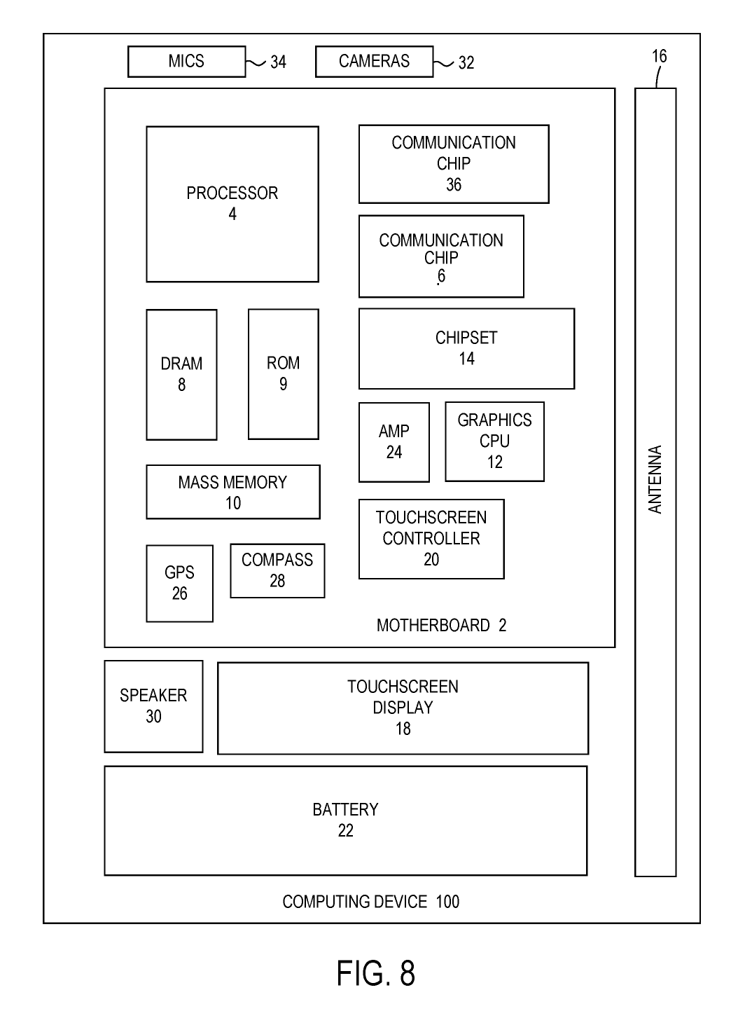

FIG. 8 illustrates a portable image capture device 100 in accordance with one implementation. The imaging device 100 houses a system board 2. The board 2 may include a number of components, including but not limited to a processor 4 and at least one communication package 6. The communication package may be coupled to one or more antennas 16. The processor 4 is physically and electrically coupled to the board 2.

Depending on its applications, image capture device 100 may include other components that may or may not be physically and electrically coupled to the board 2. These other components include, but are not limited to, volatile memory (e.g., DRAM) 8, non-volatile memory (e.g., ROM) 9, flash memory (not shown), a graphics processor 12, a digital signal processor (not shown), a crypto processor (not shown), a chip set 14, an antenna 16, a display 18 such as a touchscreen display, a touchscreen controller 20, a battery 22, an audio codec (not shown), a video codec (not shown), a power amplifier 24, a global positioning system (GPS) device 26, a compass 28, an accelerometer (not shown), a gyroscope (not shown), a speaker 30, one or more cameras 32, a microphone array 34, and a mass storage device (such as hard disk drive) 10, compact disk (CD) (not shown), digital versatile disk (DVD) (not shown), and so forth). These components may be connected to the system board 2, mounted to the system board, or combined with any of the other components.

The camera array may be coupled to an image chip 36, such as an imaging signal processor and to the processor 4, either directly or through the image chip. The image chip may take a variety of different forms, such as a graphics co-processor, or a separate dedicated imaging management module. Such a module or device may comprise logic, algorithms, and/or instructions operative to capture, process, edit, compress, store, print, and/or display one or more images. These processes may include de-noising, image recognition, image enhancement and other processes described herein. In some embodiments, the imaging management module may comprise programming routines, functions, and/or processes implemented as software within an imaging application or operating system. In various other embodiments, the imaging management module may be implemented as a standalone chip or integrated circuit, or as circuitry comprised within the processor, within a CPU, within a graphics chip or other integrated circuit or chip, or within a camera module.

The communication package 6 enables wireless and/or wired communications for the transfer of data to and from the video device 100. The term “wireless” and its derivatives may be used to describe circuits, devices, systems, methods, techniques, communications channels, etc., that may communicate data through the use of modulated electromagnetic radiation through a non-solid medium. The term does not imply that the associated devices do not contain any wires, although in some embodiments they might not. The communication package 6 may implement any of a number of wireless or wired standards or protocols, including but not limited to Wi-Fi (IEEE 802.11 family), WiMAX (IEEE 802.16 family), IEEE 802.20, long term evolution (LTE), Ev-DO, HSPA+, HSDPA+, HSUPA+, EDGE, GSM, GPRS, CDMA, TDMA, DECT, Bluetooth, Ethernet derivatives thereof, as well as any other wireless and wired protocols that are designated as 3G, 4G, 5G, and beyond. The video device 100 may include a plurality of communication packages 6. For instance, a first communication package 6 may be dedicated to shorter range wireless communications such as Wi-Fi and Bluetooth and a second communication package 6 may be dedicated to longer range wireless communications such as GPS, EDGE, GPRS, CDMA, WiMAX, LTE, Ev-DO, and others.

Cameras 32 may include all of the components of the camera or share resources, such as memory 8, 9, 10, processing 4 and user interface 12, 20, with other video device components and functions. The processor 4 is coupled to the camera and to memory to receive frames and produce enhanced images. In one embodiment, cameras 32 include an image capture sensor(s) and color filter array describe above. In one embodiment, cameras 32 also include an image processing system, as described above.

In various implementations, the image capture device 100 may be a video camera, a digital single lens reflex or mirror-less camera, a cellular telephone, a media player, laptop, a netbook, a notebook, an ultrabook, a smartphone, a wearable device, a tablet, a personal digital assistant (PDA), an ultra mobile PC, or a digital video recorder. The image capture device may be fixed, portable, or wearable. In further implementations, the image capture device 100 may be any other electronic device that records a sequence of image frames and processes data.

FIG. 8 illustrates a portable image capture device 100 in accordance with one implementation. The imaging device 100 houses a system board 2. The board 2 may include a number of components, including but not limited to a processor 4 and at least one communication package 6. The communication package may be coupled to one or more antennas 16. The processor 4 is physically and electrically coupled to the board 2.

Depending on its applications, image capture device 100 may include other components that may or may not be physically and electrically coupled to the board 2. These other components include, but are not limited to, volatile memory (e.g., DRAM) 8, non-volatile memory (e.g., ROM) 9, flash memory (not shown), a graphics processor 12, a digital signal processor (not shown), a crypto processor (not shown), a chipset 14, an antenna 16, a display 18 such as a touchscreen display, a touchscreen controller 20, a battery 22, an audio codec (not shown), a video codec (not shown), a power amplifier 24, a global positioning system (GPS) device 26, a compass 28, an accelerometer (not shown), a gyroscope (not shown), a speaker 30, one or more cameras 32, a microphone array 34, and a mass storage device (such as hard disk drive) 10, compact disk (CD) (not shown), digital versatile disk (DVD) (not shown), and so forth). These components may be connected to the system board 2, mounted to the system board, or combined with any of the other components.

The camera array may be coupled to an image chip 36, such as an imaging signal processor and to the processor 4, either directly or through the image chip. The image chip may take a variety of different forms, such as a graphics co-processor, or a separate dedicated imaging management module. Such a module or device may comprise logic, algorithms, and/or instructions operative to capture, process, edit, compress, store, print, and/or display one or more images. These processes may include de-noising, image recognition, image enhancement and other processes described herein. In some embodiments, the imaging management module may comprise programming routines, functions, and/or processes implemented as software within an imaging application or operating system. In various other embodiments, the imaging management module may be implemented as a standalone chip or integrated circuit, or as circuitry comprised within the processor, within a CPU, within a graphics chip or other integrated circuit or chip, or within a camera module.

The communication package 6 enables wireless and/or wired communications for the transfer of data to and from the video device 100. The term “wireless” and its derivatives may be used to describe circuits, devices, systems, methods, techniques, communications channels, etc., that may communicate data through the use of modulated electromagnetic radiation through a non-solid medium. The term does not imply that the associated devices do not contain any wires, although in some embodiments they might not. The communication package 6 may implement any of a number of wireless or wired standards or protocols, including but not limited to Wi-Fi (IEEE 802.11 family), WiMAX (IEEE 802.16 family), IEEE 802.20, long term evolution (LTE), Ev-DO, HSPA+, HSDPA+, HSUPA+, EDGE, GSM, GPRS, CDMA, TDMA, DECT, Bluetooth, Ethernet derivatives thereof, as well as any other wireless and wired protocols that are designated as 3G, 4G, 5G, and beyond. The video device 100 may include a plurality of communication packages 6. For instance, a first communication package 6 may be dedicated to shorter range wireless communications such as Wi-Fi and Bluetooth and a second communication package 6 may be dedicated to longer range wireless communications such as GPS, EDGE, GPRS, CDMA, WiMAX, LTE, Ev-DO, and others.

Cameras 32 may include all of the components of the camera or share resources, such as memory 8, 9, 10, processing 4 and user interface 12, 20, with other video device components and functions. The processor 4 is coupled to the camera and to memory to receive frames and produce enhanced images. In one embodiment, cameras 32 include an image capture sensor(s) and color filter array describe above. In one embodiment, cameras 32 also include an image processing system, as described above.

In various implementations, the image capture device 100 may be a video camera, a digital single lens reflex or mirror-less camera, a cellular telephone, a media player, laptop, a netbook, a notebook, an ultrabook, a smartphone, a wearable device, a tablet, a personal digital assistant (PDA), an ultra mobile PC, or a digital video recorder. The image capture device may be fixed, portable, or wearable. In further implementations, the image capture device 100 may be any other electronic device that records a sequence of image frames and processes data.

In a first example embodiment, a system comprises an image capture unit having an image capture sensor and an image processor comprising a first module operable to perform joint edge enhancement and demosaic processing.

In another example embodiment, the subject matter of the first example embodiment can optionally include that the joint edge enhancement and demosaic processing is operable to extract edge information and a base signal directly from a color filter array image.

In another example embodiment, the subject matter of the first example embodiment can optionally include that the first module performs the joint edge enhancement and demosaic processing by: performing luma edge interpolation on image data from a color filter array image; generating direction information indicative of an interpolation direction; and merging edges for different directions based on the direction information to generate processed image data. In another example embodiment, the subject matter of this example embodiment can optionally include that the first processor module is operable to apply a non-linear transform to an input of the luma edge interpolation. In another example embodiment, the subject matter of this example embodiment can optionally include that the non-linear transform comprises a gamma transform.

In another example embodiment, the subject matter of the first example embodiment can optionally include that the first module is operable to generate the direction information indicative of an interpolation direction by performing integrated gradient extraction.

In another example embodiment, the subject matter of the first example embodiment can optionally include that the first module is operable to perform luma edge enhancement by adding the processed image data to an interpolated base signal.

In another example embodiment, the subject matter of the first example embodiment can optionally include that the image processing unit comprises one or more additional modules to perform at least one additional image processing operation. In another example embodiment, the subject matter of this example embodiment can optionally include that the at least one additional image processing operation includes one selected from a group consisting of color correction, gamma correction, and color processing or can optionally include the at least one additional image processing operation comprises color correction, gamma correction, and color processing.

In a second example embodiment, an image processor comprises an input to receive a color filter array image and a first processor module operable to perform joint edge enhancement and demosaic processing on the color filter array image.

In another example embodiment, the subject matter of the second example embodiment can optionally include that first processor module is operable to extract edge information and a base signal directly from the color filter array image.

In another example embodiment, the subject matter of the second example embodiment can optionally include that the first processor module performs the joint edge enhancement and demosaic processing by performing luma edge interpolation on image data from the color filter array image, generating direction information indicative of an interpolation direction and merging edges for different directions based on the direction information to generate processed image data. In another example embodiment, the subject matter of this example embodiment can optionally include that the first processor module is operable to apply a non-linear transform to an input of the luma edge interpolation. In another example embodiment, the subject matter of this example embodiment can optionally include that the non-linear transform comprises a gamma transform.

In another example embodiment, the subject matter of the second example embodiment can optionally include that the first processor module is operable to generate the direction information indicative of an interpolation direction by performing integrated gradient extraction.

In another example embodiment, the subject matter of the second example embodiment can optionally include that the first processor module is operable to perform luma edge enhancement by adding the processed image data to an interpolated base signal.

In another example embodiment, the subject matter of the second example embodiment can optionally include one or more additional processor modules to perform at least one additional image processing operation. In another example embodiment, the subject matter of this example embodiment can optionally include that the at least one additional image processing operation includes one selected from a group consisting of color correction, gamma correction, and color processing or optionally include that the at least one additional image processing operation comprises color correction, gamma correction, and color processing.

In a third example embodiment, an image processing method for processing image data of a color filter array image, comprises receiving image data captured using an image sensor with a color filter array and performing joint edge enhancement and demosaic processing on data of the color filter array image, including extracting edge information and a base signal directly from the color filter array image data.

In another example embodiment, the subject matter of the third example embodiment can optionally include that performing the joint edge enhancement and demosaic processing comprises performing luma edge interpolation on image data from the color filter array image, generating direction information indicative of an interpolation direction, and merging edges for different directions based on the direction information to generate processed image data. In another example embodiment, the subject matter of this example embodiment can optionally include applying a non-linear transform to an input of the luma edge interpolation. In another example embodiment, the subject matter of this example embodiment can optionally include that the non-linear transform comprises a gamma transform.

In another example embodiment, the subject matter of the third example embodiment can optionally include that generating the direction information indicative of an interpolation direction comprises performing integrated gradient extraction.

In another example embodiment, the subject matter of the third example embodiment can optionally include performing luma edge enhancement by adding the processed image data to an interpolated base signal.

In another example embodiment, the subject matter of the third example embodiment can optionally include performing color correction to create color corrected image data, performing gamma correction on the color corrected image data to produce gamma corrected image data, and performing color processing on the gamma corrected image data.

In a fourth example embodiment, an article of manufacture has one or more non-transitory computer readable media storing instructions which, when executed by a system, cause the system to perform a method comprising receiving image data captured using an image sensor with a color filter array and performing joint edge enhancement and demosaic processing on data of the color filter array image, including extracting edge information and a base signal directly from the color filter array image data.

In another example embodiment, the subject matter of the fourth example embodiment can optionally include that performing the joint edge enhancement and demosaic processing comprises performing luma edge interpolation on image data from the color filter array image, generating direction information indicative of an interpolation direction, and merging edges for different directions based on the direction information to generate processed image data.

In another example embodiment, the subject matter of the fourth example embodiment can optionally include that the method further comprises applying a non-linear transform to an input of the luma edge interpolation.

Some portions of the detailed descriptions above are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussion, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

The present invention also relates to apparatus for performing the operations herein. This apparatus may be specially constructed for the required purposes, or it may comprise a general purpose computer selectively activated or reconfigured by a computer program stored in the computer. Such a computer program may be stored in a computer readable storage medium, such as, but is not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions, and each coupled to a computer system bus.

The algorithms and displays presented herein are not inherently related to any particular computer or other apparatus. Various general purpose systems may be used with programs in accordance with the teachings herein, or it may prove convenient to construct more specialized apparatus to perform the required method steps. The required structure for a variety of these systems will appear from the description below. In addition, the present invention is not described with reference to any particular programming language. It will be appreciated that a variety of programming languages may be used to implement the teachings of the invention as described herein.

A machine-readable medium includes any mechanism for storing or transmitting information in a form readable by a machine (e.g., a computer). For example, a machine-readable medium includes read only memory (“ROM”); random access memory (“RAM”); magnetic disk storage media; optical storage media; flash memory devices; etc.

Whereas many alterations and modifications of the present invention will no doubt become apparent to a person of ordinary skill in the art after having read the foregoing description, it is to be understood that any particular embodiment shown and described by way of illustration is in no way intended to be considered limiting. Therefore, references to details of various embodiments are not intended to limit the scope of the claims which in themselves recite only those features regarded as essential to the invention.

We claim:

1. A system comprising:
an image capture unit having an image capture sensor; and
an image processor comprising a first module operable to perform joint edge enhancement and demosaic processing.

2. The system defined in claim 1 wherein the joint edge enhancement and demosaic processing is operable to extract edge information and a base signal directly from a color filter array image.

3. The system defined in claim 1 wherein the first module performs the joint edge enhancement and demosaic processing by:
performing luma edge interpolation on image data from a color filter array image;
generating direction information indicative of an interpolation direction; and
merging edges for different directions based on the direction information to generate processed image data.

4. The system defined in claim 3 wherein the first processor module is operable to apply a non-linear transform to an input of the luma edge interpolation.

5. The system defined in claim 4 wherein the non-linear transform comprises a gamma transform.

6. The system defined in claim 3 wherein the first module is operable to generate the direction information indicative of an interpolation direction by performing integrated gradient extraction.

7. The system defined in claim 3 wherein the first module is operable to perform luma edge enhancement by adding the processed image data to an interpolated base signal.

8. The system defined in claim 1 wherein the image processing unit comprises one or more additional modules to perform at least one additional image processing operation.

9. The system defined in claim 8 wherein the at least one additional image processing operation includes one selected from a group consisting of color correction, gamma correction, and color processing.

10. The system defined in claim 8 wherein the at least one additional image processing operation comprises color correction, gamma correction, and color processing.

11. An image processor comprising:
an input to receive a color filter array image; and
a first processor module operable to perform joint edge enhancement and demosaic processing on the color filter array image.

12. The image processor defined in claim 11 wherein first processor module is operable to extract edge information and a base signal directly from the color filter array image.

13. The image processor defined in claim 11 wherein the first processor module performs the joint edge enhancement and demosaic processing by:
performing luma edge interpolation on image data from the color filter array image;
generating direction information indicative of an interpolation direction; and
merging edges for different directions based on the direction information to generate processed image data.

14. The image processor defined in claim 13 wherein the first processor module is operable to apply a non-linear transform to an input of the luma edge interpolation.

15. The image processor defined in claim 14 wherein the non-linear transform comprises a gamma transform.

16. The image processor defined in claim 13 wherein the first processor module is operable to generate the direction information indicative of an interpolation direction by performing integrated gradient extraction.

17. The image processor defined in claim 13 wherein the first processor module is operable to perform luma edge enhancement by adding the processed image data to an interpolated base signal.

18. The image processor defined in claim 11 further comprising one or more additional processor modules to perform at least one additional image processing operation.

19. The image processor defined in claim 18 wherein the at least one additional image processing operation includes one selected from a group consisting of color correction, gamma correction, and color processing.

20. The image processor defined in claim 18 wherein the at least one additional image processing operation comprises color correction, gamma correction, and color processing.

21. An image processing method for processing image data of a color filter array image, the method comprising:
receiving image data captured using an image sensor with a color filter array; and
performing joint edge enhancement and demosaic processing on data of the color filter array image, including extracting edge information and a base signal directly from the color filter array image data.

22. The image processing method defined in claim 21 wherein performing the joint edge enhancement and demosaic processing comprises:
performing luma edge interpolation on image data from the color filter array image;
generating direction information indicative of an interpolation direction; and
merging edges for different directions based on the direction information to generate processed image data.

23. The image processing method defined in claim 22 further comprising applying a non-linear transform to an input of the luma edge interpolation.

24. The image processing method defined in claim 23 wherein the non-linear transform comprises a gamma transform.

25. The image processing method defined in claim 22 wherein generating the direction information indicative of an interpolation direction comprises performing integrated gradient extraction.

26. The image processing method defined in claim 22 further comprising performing luma edge enhancement by adding the processed image data to an interpolated base signal.

27. The image processing method defined in claim 21 further comprising:
performing color correction to create color corrected image data;
performing gamma correction on the color corrected image data to produce gamma corrected image data; and
performing color processing on the gamma corrected image data.

28. An article of manufacture having one or more non-transitory computer readable media storing instructions which, when executed by a system, cause the system to perform a method comprising:
receiving image data captured using an image sensor with a color filter array; and
performing joint edge enhancement and demosaic processing on data of the color filter array image, including extracting edge information and a base signal directly from the color filter array image data.

29. The article of manufacture defined in claim 28 wherein performing the joint edge enhancement and demosaic processing comprises:
performing luma edge interpolation on image data from the color filter array image;
generating direction information indicative of an interpolation direction; and
merging edges for different directions based on the direction information to generate processed image data.

30. The article of manufacture defined in claim 29 wherein the method further comprises applying a non-linear transform to an input of the luma edge interpolation.
